(19) United States
(12) Patent Application Publication
(10) Pub. No.: US 2010/0333115 A1
(43) Pub. Date: Dec. 30, 2010

(54) SYSTEM AND METHOD FOR A SOURCE-INDEPENDENT SERVER INTERFACE ACCEPTING ORIGIN SPECIFIC COMMANDS

(75) Inventors: Nathan YOSPE, Glendale, CA (US); Simon Shpilfoygel, Los Angeles, CA (US)

Correspondence Address: SAP_DLG, 117 E. Colorado Blvd., Suite 460, Pasadena, CA, 91105, US

(73) Assignee: SAP AG, Walldorf (DE)

(21) Appl. No.: 12/495,512

(22) Filed: Jun. 30, 2009

(51) Int. Cl. G06F 9/46

(52) U.S. Cl. 719/328; 719/330

(57) ABSTRACT

One or more embodiments of the invention enable a system and method for a source-independent server interface accepting origin-specific commands. A system and process are described for a source-independent server interface accepting origin-specific commands comprising: a computer; a computer-readable medium coupled to the computer, the computer-readable medium further comprising computer-readable instructions and data, the computer-readable instructions and data configured to perform an automated process to be executed by the computer, the automated process comprising the steps of: accepting a request to execute a command from a command origin of a plurality of command origins; constructing an origin-independent command object; submitting the origin-independent command object to an execution framework for execution; and executing a command of the origin-independent command object by forwarding to an origin proxy of the execution framework the origin-independent command object with a result-reporting object. The invention allows adding multiple command origins for a legacy command server without requiring origin-specific knowledge in the server program.

### BACKGROUND OF THE INVENTION

1. Field of the Invention

Embodiments of the invention described herein pertain to the field of computer systems. More particularly, but not by way of limitation, one or more embodiments of the invention enable a system and method for a source-independent server interface accepting origin-specific commands.

2. Description of the Related Art

Legacy systems incur increasing maintenance costs over time in part because new requirements to support additional interfaces require alterations to system architecture or design never intended to support the newly required interface. Hacks and kluges are developed to keep the old system functioning as an alternative to developing and plugging in a new system with potentially catastrophic unknown bugs into a functioning product. At some point late in its maintenance lifecycle, some systems will contain more “work-arounds” than original design. Adding to the upgrade dilemma, the tools and programmers skilled to use them required to maintain the legacy system will become a barrier to updating the system to accept input from new and varied sources. In some circumstances a requirement will be added to a legacy system to support an interface to a “new” legacy system who's Application Program Interfaces (“APIs”) may be rigidly defined.

In the past, a server execution framework would have received a command, perhaps as a TCP request with a handle that provides an ID for a command, and would look up an instruction set for that command, unpacked the command data, and then performed a lock on needed resources as requested, all according to the command definition. Next, the execution framework would execute the command, populate the return structure with the result, otherwise package, format or serialize the return data, when appropriate as needed by the caller (with the server needing to know when this was required based on command origin), and returns the results and/or status as appropriate and exit. As each new application is added to those the server must serve, creating new interface code for each new origin confounds good design practices, possibly introduces errors into existing interfaces, and creates a maintenance nightmare. Still, with enough labor and careful redesign after redesign it is possible to continue to support new interfaces for the command server. It would be preferable, however, to have a new approach that guarantees a consistent behavior for any command no matter its origin because any given command is always processed by the same code in the server code. This approach would simplify maintenance, documentation, debugging and reliability testing of a command server.

A server designed to perform commands from external programs may be disadvantaged when a new source (“origin”) is defined that does not conform to the inherent design assumptions built into the server. When the origin is also a legacy system with an inflexible API incapable of exchanging data with the server in an arbitrary format and order via an arbitrary medium, the task of integrating the two programs is further complicated. Therefore, it would be advancement in the art to define a system and method that could isolate the interface assumptions inherent in a legacy server design and allow the legacy server to accept command data independent of origin without requiring alteration of the foreign API.

For at least the limitations described above there is a need for a system and method for a source-independent server interface accepting origin-specific commands.

### BRIEF SUMMARY OF THE INVENTION

One or more embodiments of the invention enable a system and method for a source-independent server interface accepting origin-specific commands. A system and process are described for a source-independent server interface accepting origin-specific commands comprising: a computer; a computer-readable medium coupled to the computer, the computer-readable medium further comprising computer-readable instructions and data, the computer-readable instructions and data configured to perform an automated process to be executed by the computer, the automated process comprising the steps of: accepting a request to execute a command from a command origin of a plurality of command origins; constructing an origin-independent command object; submitting the origin-independent command object to an execution framework for execution; and executing a command of the origin-independent command object by forwarding to an origin proxy of the execution framework the origin-independent command object with a result-reporting object. The invention allows adding multiple command origins for a legacy command server without requiring origin-specific knowledge in the server program.

The invention further comprises using a new interface class to provide the legacy server with a consistent command interface no matter what type of application origin wishes to access the server. A new interface class does not require redesign of the legacy server to accept a new origin, nor does it require major revision of the application program. This approach may be a particular advantage when the application being interfaced to the legacy server is itself a legacy program whose significant revision is impossible or undesirable. Isolating a new server command interface into an interface class provides the benefit of supporting communication between the various programs while reducing redesign and reprogramming and therefore maintenance costs for both the server and its applications. Such an architectural approach allows any other foreign application or process wishing to use a new communication method or format to pass commands to the legacy server in a consistent and predictable manner.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an overview of the structure of a source-independent server interface accepting origin-specific commands in one or more embodiments of the invention.

FIG. 2 illustrates an exemplary class diagram for a source-independent server interface accepting origin-specific commands for one or more embodiments of the invention

FIG. 3 illustrates an exemplary event flow diagram for both synchronous and asynchronous commands from internal origins for one or more embodiments of the invention

FIG. 4 illustrates an exemplary event flow diagram for commands originating from alternative legacy application program interfaces from internal origins for one or more embodiments of the invention

FIG. 5 illustrates an exemplary event flow diagram for replication (replay) origin commands for one or more embodiments of the invention.

FIG. 6 illustrates an exemplary event flow diagram for application program interface legacy application origins for one or more embodiments of the invention.

FIG. 7 illustrates a general-purpose computer and peripherals that when programmed as described herein may operate as a programmed computer capable of implementing one or more methods, apparatus and/or systems of the invention.

### DETAILED DESCRIPTION

A system and method for a source-independent server interface accepting origin-specific commands will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

Where a legacy command server (“server” or “command server”) performing commands issued by a foreign application program interface (“API”) acquires a new requirement to support a command communication channel with very different characteristics from those of previously supported channels, a design need arises to isolate the assumptions inherent in the legacy server design from the foreign API and its design. As used herein, the term “legacy” refers to a program that was developed at some time in the past and is still in use, even though it comprises older technology than the systems that surround it. Legacy programs present a significant challenge to companies as such programs may have had many changes over the years, have few employees who understand the programs' design, and the programs may require use of out-of-date languages and tools to effect changes. Also as used herein, various source programs, formats, and protocols for issuing server commands may be called an “origin.” Different origins may use the same communication format and methodology as previous interfacing origins or may follow a unique communication format to send commands to a server. The term “origins,” as used herein may include a plurality of forms, for example, TCP clients, RPC interfaces, and both asynchronous and synchronous commands from internal communication interfaces. Where a requirement to add support for a new origin to legacy server arises, a challenging task ensues. One solution is to add an isolating layer to the server architecture to provide support for new command origins, but this may increase maintenance and complexity of the legacy server, slow the operation and execution of commands, and may require the new calling application, along with all other applications already served, to be modified to accommodate the modified server interface.

The present invention instead teaches the creation of a new interface class that provides the legacy server with a consistent command interface no matter what type of application wishes to access the server. A new interface class does not require alteration of the legacy server to accept a new origin, and may be a particular advantage when the application being interfaced to the legacy server is itself a legacy program whose revision is undesirable. Isolating a new server command interface into an interface class therefore provides the benefit of supporting the communication between the various programs while reducing redesign and reprogramming, and therefore maintenance costs, for both the server and its applications. Such an architectural approach allows any other foreign application or process wishing to use a new communication method or format to pass commands to the legacy server in a reliable manner.

A solution in the nature of the invention may thus reduce the definition of a task interface to a command server to a bare minimum. For example, where a server is configured to accept commands from TCP clients using existing APIs (such as a User Interface application, a Java API application or a .NET API application), an additional requirement to accept commands from a proprietary legacy remote procedure call (RPC) type interface, an internal communications interface for asynchronous events, or an internal communications interface for synchronous events, for example, may create a need to re-architect or redesign the server program. This may arise, for example, from new requirements to manage resource locking for the new command source. Synchronous commands origins may break down into multiple types such as composite task or journaling task, for example.

One or more embodiments of the invention may support a server command interface implemented as an abstract class for providing a command interface for all commands. A command interface class in the nature of the invention may accept, process, and pass on a command to the server executing framework from any of a set of recognized origins. It may handle synchronous and asynchronous input, as well as manage serialization and deserialization of input commands. It may also manage input parameters and handle returning a result where appropriate. Finally, the command interface of the invention may also support ancillary functions of the server in a consistent fashion, such as logging, error handling, providing status information, timing commands and other similar functions. The class of the invention may be expandable to handle other interface forms than those exemplified herein.

Using the origin-independent command interface object of the invention, the command server need not contain, nor be modified to contain, any code in the nature of “if command origin=X then do Y,” even when a new command interface requirement is added to the server. In other words, using the method of the invention the server need not contain any origin specific code at all. In essence, an object representing a command may be provided by the origin (created by the “client side”) and passed into the framework (sent over the network) to represent the command to the framework. The origin/client may create the object in one or more embodiments using a plug-in factory or other similar mechanism understood by those of ordinary skill in the art. Origins may create commands using whatever mechanism is available; including those described herein which are well understood by those of ordinary skill in the art.

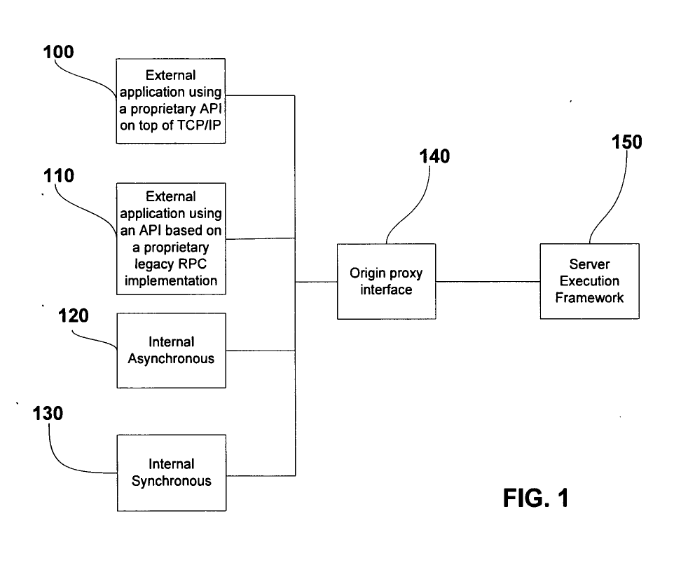

FIG. 1 illustrates an overview of the structure of a source-independent server interface accepting origin-specific commands in one or more embodiments of the invention. Boxes 100, 110, 120 and 130 represent examples of various possible origins of commands for server execution framework 150 in one or more embodiments of the invention. Origin proxy interface 140 provides a source-independent interface for server execution framework 150. Origin proxy interface 140 separates origin-specific behaviors from server execution framework 150. According to one or more embodiments of the invention other types of origins may be added to the system without requiring modification of server execution framework 150.

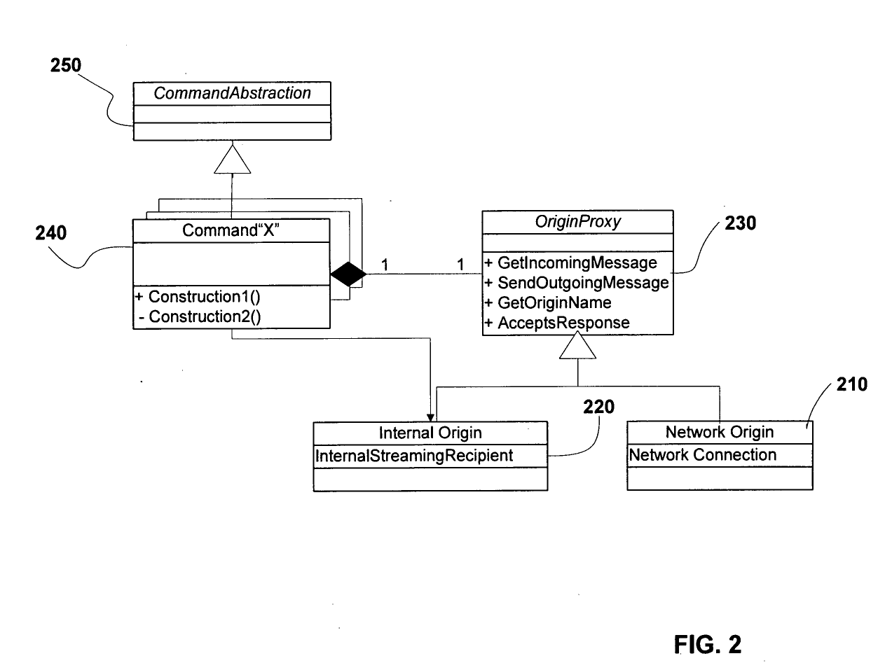

FIG. 2 illustrates an exemplary class diagram for a source-independent server interface accepting origin-specific commands for one or more embodiments of the invention. In this example, CommandAbstraction class 250 is a super class abstraction of concrete class CommandX 240. CommandX 240 aggregates OriginProxy interface 230 in a 1 to 1 mapping to CommandX 240. CommandX 240 thus comprises OrginProxy interface 230, and also comprises both public and private methods for constructing commands. OriginProxy interface 230 may contain public methods for getting and sending messages, getting origin name, and querying whether the origin accepts responses. InternalOrigin 220 and NetworkOrigin 210 inherit OriginProxy interface 230, providing attributes for each type of interface in one or more embodiments of the invention. In one or more embodiments all origin-specific operations in Command class 250 are executed by forwarding to OriginProxy interface 230.

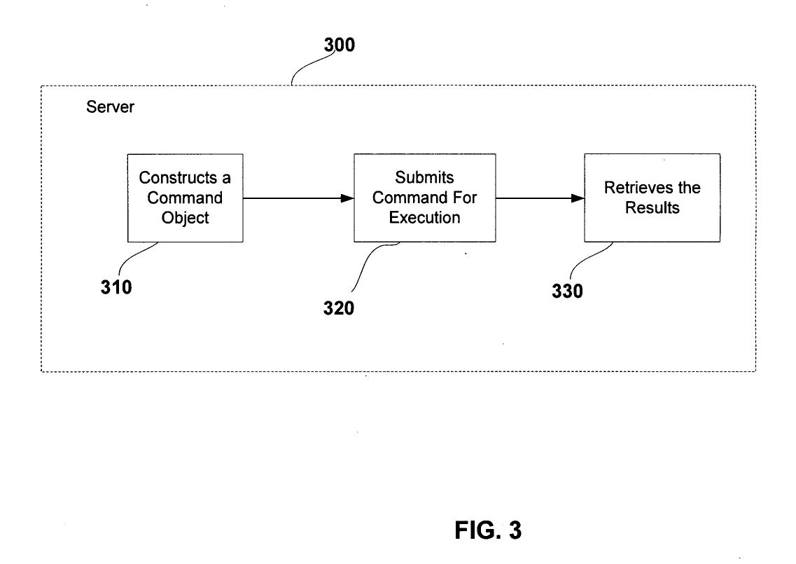

FIG. 3 illustrates an exemplary event flow diagram for both asynchronous 120 and synchronous 130 command types from internal origins for one or more embodiments of the invention. In FIG. 3 to FIG. 6, broken lines are used to software components (such as server, client applications, journal entry broker for journaling transactions, or a transmission component). Where the command request is from an internal source in one or more embodiments, server 300 may construct a command object at step 310, submit a command for execution at step 320 and then retrieve results from the command object at step 330. This example may be appropriate for command sources such as a scheduled operation performed by a workflow engine (asynchronous) or for a synchronous origin that is implementing a larger operation via a series of existing smaller operations. Here, as elsewhere herein, Submit Command for Execution 320 represents invoking the execution framework that executes the command and may simultaneously perform additional functions such as logging, monitoring and/or timing command execution, may acquire necessary locks on resources, may journal transactions and may handle execution errors in one or more embodiments, for example. In the invention these additional functions may be performed in a consistent fashion regardless of the origin of the original command.

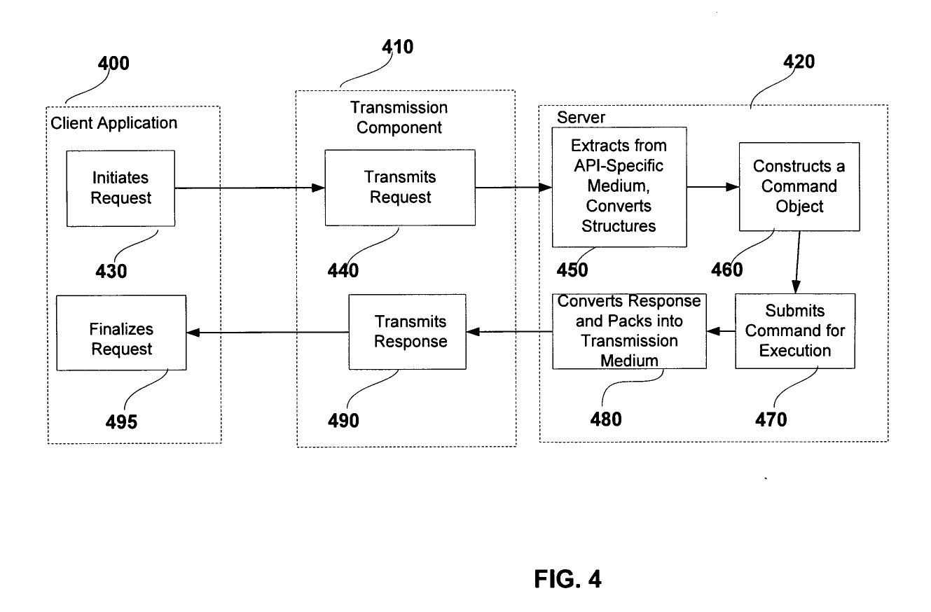

FIG. 4 illustrates an exemplary event flow diagram for commands originating from alternative legacy application program interface and routed through an internal origin for one or more embodiments of the invention. In one or more embodiments, a mechanism for passing origin objects to the execution framework server may include using a remote procedure call (RPC) interface to access Server 420. As a particular embodiment, SAP's Remote Function Calls (RFC) may be used to access Server 420. Commands of this origin may come in using User Datagram Protocol (UDP) shared memory, or a memory map, if the command is local to the server. It would be advantageous if commands from RPC/RFC calls appeared as TCP/IP commands to the Server 420. In such an embodiment, Client Application 400 may initiate a command execution request at step 430. Transmission Component 410 transmits 440 the request and any associated attributes to Server 420. Server 420 may then extract the command from the API-specific medium, converting structures where required, and construct a command object, such as CommandX 240, at step 460. At step 470 Server 420 may submit the command object for execution. Following execution, at step 480, Server 420 may then convert the command results and repackage to the API-specific medium. Next, the response may be transmitted back via Transmission Component 410 at step 490 to Client Application 400, which receives the result at step 495 where the request is finalized in one or more embodiments of the invention.

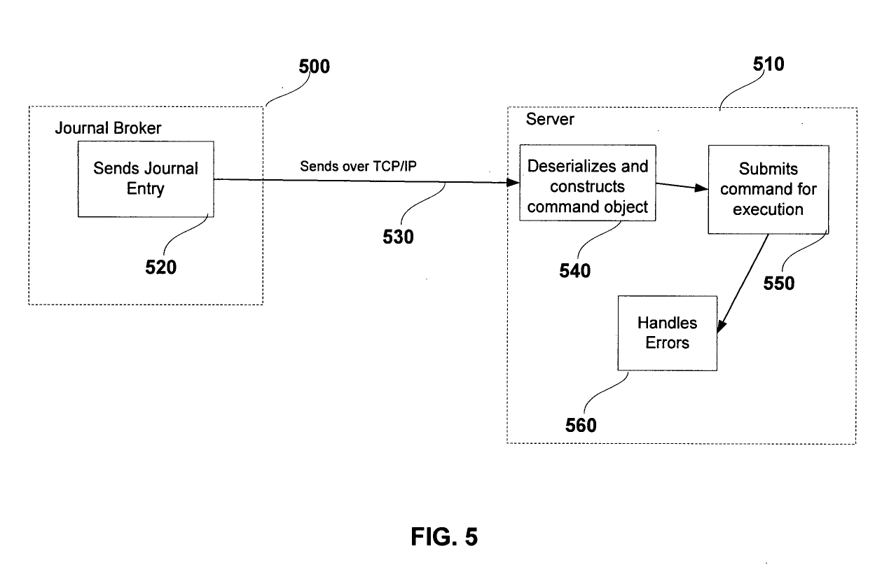

FIG. 5 illustrates an exemplary event flow diagram for replication (replay) origin commands for one or more embodiments of the invention. In this origin, a Journal Broker 500 may send a journal entry 520 over TCP/IP connection 530 to Server 510. Server 510 may then deserialize and construct a command object at step 540. Next, Server 510 may submit the command object for execution at step 550, and handle errors during execution, for example, at step 560.

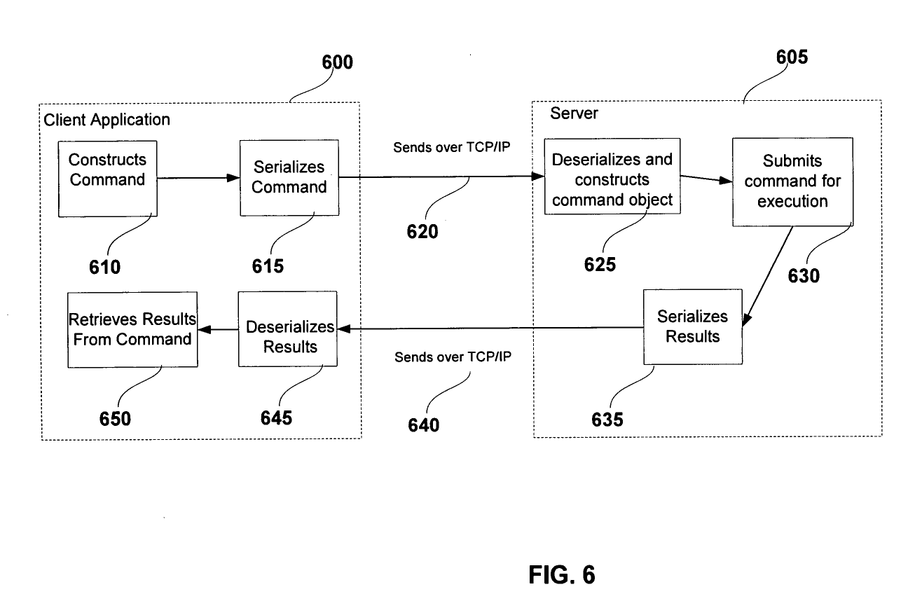

FIG. 6 illustrates an exemplary event flow diagram for application program interface legacy application origins for one or more embodiments of the invention. In this embodiment, Client Application 600 may construct a command at step 610 and serialize it at step 615. The command is sent over TCP/IP connection 620 to Server 605, which may deserialize the command and construct a command object at step 625. Next, Server 605 may submit the command object for execution at step 630. Following execution, Server 605 may serialize the result at step 635, and send the result back to Client Application 600 via TCP/IP connection 640. TCP/IP connection 620 and 640 may be the same connection, or a different connection in one or more embodiments of the invention. At step 645 the Client Application may receive the result and deserialize it, returning the result as a command response at step 650.

Each of the origins exemplified herein may be present alone or one, more or all combined in various embodiments of the invention. The invention provides a computerized method for processing commands from multiple origins but is not restricted to a particular individual origin or combination of origins.

A command communication interface solution in the nature of the invention may also be expanded in the same way to encompass other origin-specific activities as well. For example, origins may request a server perform atomic commands that are part of a bigger task. Thus, a class interface may be designed that allow a group of commands themselves to act as an origin. Groups of commands may request the server lock a resource, for example. Groups of commands may also be stacked. Other origin-specific activities supported by the approach of the invention may include returning status on server activities, such as reporting back that a command in progress is x% complete, for example.

### Computer System Architecture

The method described here is not limited as to the type of computer it may run upon and may for instance operate on any generalized computer system that has the computational ability to execute the methods described herein and can display the results of the users choices on a display means. The computer typically includes at least a keyboard, a display device such as a monitor, and a pointing device such as a mouse. The computer also typically comprises a random access memory, a read only memory, a central processing unit and a storage device such as a hard disk drive. In some embodiments of the interface, the computer may also comprise a network connection that allows the computer to send and receive data through a computer network such as the Internet. Mobile computer platforms such as cellular telephones, smart phone, Personal Desktop Assistants (PDAs), kiosks, set top boxes, games boxes or any other computational device, portable, personal or otherwise, may also qualify as a computer system capable of executing the methods described herein.

In various embodiments, the present invention may be implemented as a method, apparatus, or article of manufacture using standard “programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network. The article of manufacture in which the code is implemented also encompasses transmission media, such as the network transmission line and wireless transmission media. Thus, the article of manufacture also comprises the medium in which the code is embedded. Those skilled in the art will recognize that many modifications may be made to this configuration without departing from the scope of the present invention.

Embodiments of the system to order tasks with complex interrelationships may be embodied in software that may execute on one or more computers having a computer-usable tangible memory medium (or a computer readable memory medium) and computer readable program code. The computer readable program code may include an input function, to acquire task relationships. The various ordering functions are configured to handle task constraints as described elsewhere herein.

Furthermore, embodiments of the present invention may be implemented as a program of computer-readable instructions and/or computer-readable data stored on a computer-readable medium. Programs, data and other information may constitute, but are not limited to, sets of computer instructions, code sequences, configuration information, and other information in any form, format or language usable by a general purpose computer or other processing device, such that when such a computer contains, is programmed with, or has access to said programs, data and other information said general purpose computer is transformed into a machine capable of ordering tasks with complex interrelationships, such as those described above. A computer-readable medium suitable to provide computer readable instructions and/or computer readable data for the methods and processes described herein may be any type of magnetic, optical, or electrical storage medium including a disk, tape, CD, DVD, flash drive, thumb drive, storage card, or any other memory device or other storage medium known to those of skill in the art.

In one or more embodiments of the invention, the methods described here may not be limited as to the type of computer it may run upon and may for instance operate on any generalized computer system that has the computational ability to execute the methods described herein and can display the results of the user's choices on one or more display devices. Display devices appropriate for providing interaction with the invention described herein includes, but is not limited to, computer monitors, cell phones, PDAs, televisions, or any other form of computer controllable output display. As used herein, a computer system refers to but is not limited to any type of computing device, including its associated computer software, data, peripheral devices, communications equipment and any required or desired computers that may achieve direct or indirect communication with a primary computing device.

In one or more embodiments of the invention, a general-purpose computer may be utilized to implement one or more aspects of the invention. In one or more embodiments of the invention, the computer may include various input and output means, including but not limited to a keyboard or other textual input devices, a display device such as a monitor or other display screen, and a pointing device and/or user selection indicator such as a mouse, keypad, touch screen, pointing device, or other known input/output devices known to those of skill in the art. The general-purpose computer described herein may include one or more banks of random access memory, read only memory, and one or more central processing unit(s). The general-purpose computer described herein may also include one or more data storage device(s) such as a hard disk drive, or other computer readable medium discussed above. An operating system that executes within the computer memory may provide an interface between the hardware and software. The operating system may be responsible for managing, coordinating and sharing of the limited resources within the computer. Software programs that run on the computer may be performed by an operating system to provide a source-independent server interface accepting origin-specific commands of the invention with access to the resources needed to execute. In other embodiments the server interface program may run stand-alone on the processor to perform the methods described herein.

In one or more embodiments of the invention, the method(s) described herein, when loaded on or executing through or by one or more general purpose computer(s) described above, may transform the general-purpose computer(s) into a programmed computer able to perform the method or methods described herein. In one or more embodiments of the invention, the computer-readable storage medium(s) encoded with computer program instructions that, when accessed by a computer, may cause the computer to load the server interface program instructions to a memory there accessible, thereby creates a programmed computer able to perform the methods described herein as a programmed computer.

The programmed computer of the invention may also comprise a connection that allows the computer to send and/or receive data through a computer network such as the Internet or other communication network. Mobile computer platforms such as cellular telephones, Personal Desktop Assistants (PDAs), other hand-held computing devices, digital recorders, wearable computing devices, kiosks, set top boxes, games boxes or any other computational device, portable, personal, real or virtual or otherwise, may also qualify as a computer system or part of a computer system capable of executing the methods described herein as a programmed computer.

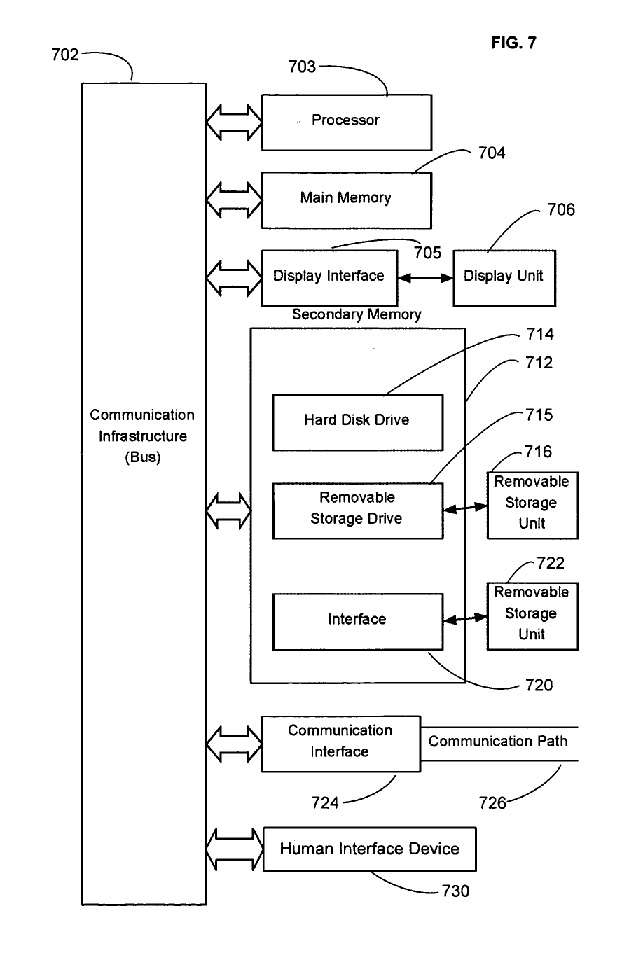

FIG. 7 depicts a general-purpose computer and peripherals, when programmed as described herein, may operate as a programmed computer capable of implementing one or more methods, apparatus and/or systems of the invention. Processor 707 may be coupled to bi-directional communication infrastructure 702 such as Communication Infrastructure System Bus 702. Communication Infrastructure 702 may generally be a system bus that provides an interface to the other components in the general-purpose computer system such as Processor 707, Main Memory 706, Display Interface 708, Secondary Memory 712 and/or Communication Interface 724.

Main memory 706 may provide a computer readable medium for accessing and executed stored data and applications. Display Interface 708 may communicate with Display Unit 710 that may be utilized to display outputs to the user of the programmed computer system. Display Unit 710 may comprise one or more monitors that may visually depict aspects of the computer program to the user. Main Memory 706 and Display Interface 708 may be coupled to Communication Infrastructure 702, which may serve as the interface point to Secondary Memory 712 and Communication Interface 724. Secondary Memory 712 may provide additional memory resources beyond main Memory 706, and may generally function as a storage location for computer programs to be executed by Processor 707. Either fixed or removable computer-readable media may serve as Secondary Memory 712. Secondary Memory 712 may comprise, for example, Hard Disk 714 and Removable Storage Drive 716 that may have an associated Removable Storage Unit 718. There may be multiple sources of Secondary Memory 712 and systems of the invention may be configured as needed to support the data storage requirements of the user and the methods described herein. Secondary Memory 712 may also comprise Interface 720 that serves as an interface point to additional storage such as Removable Storage Unit 722. Numerous types of data storage devices may serve as repositories for data utilized by the programmed computer system of the invention. For example, magnetic, optical or magnetic-optical storage systems, or any other available mass storage technology that provides a repository for digital information may be used.

Communication Interface 724 may be coupled to Communication Infrastructure 702 and may serve as a conduit for data destined for or received from Communication Path 726. A Network Interface Card (NIC) is an example of the type of device that once coupled to Communication Infrastructure 702 may provide a mechanism for transporting data to Communication Path 726. Computer networks such Local Area Networks (LAN), Wide Area Networks (WAN), Wireless networks, optical networks, distributed networks, the Internet or any combination thereof are some examples of the type of communication paths that may be utilized by the program computer system of the invention. Communication Path 726 may comprise any type of telecommunication network or interconnection fabric that can transport data to and from Communication Interface 724.

To facilitate user interaction with the programmed computer system of the invention, one or more Human Interface Devices (HID) 730 may be provided. Some examples of HIDs that enable users to input commands or data to the programmed computer of the invention may comprise a keyboard, mouse, touch screen devices, microphones or other audio interface devices, motion sensors or the like, as well as any other device able to accept any kind of human input and in turn communicate that input to Processor 707 to trigger one or more responses from the programmed computer of the invention are within the scope of the system of the invention.

While FIG. 7 depicts a physical device, the scope of the system of the invention may also encompass a virtual device, virtual machine or simulator embodied in one or more computer programs executing on a computer or computer system and acting or providing a computer system environment compatible with the methods and processes of the invention. Where a virtual machine, process, device or otherwise performs substantially similarly to that of a physical computer system of the invention, such a virtual platform will also fall within the scope of a system of the invention, notwithstanding the description herein of a physical system such as that in FIG. 7.

One or more embodiments of the invention are configured to enable the programmed computer of the invention to take the input data given and transform it into a source-independent server interface by applying one or more of the methods and/or processes of the invention as described herein. Thus the methods described herein are able to transform the raw input data, such as digital commands, to a source-independent server interface accepting origin-specific commands, using the system of the invention to result in an the server performing origin-specific commands arranged to preserve the independence of the method using the programmed computer as described herein. Particularly, the system of the invention may be programmed to acquire an object containing commands for execution and interpreting said commands in light of an origin-independent command interface.

While the invention herein disclosed has been described by means of specific embodiments and applications thereof, numerous modifications and variations could be made thereto by those skilled in the art without departing from the scope of the invention set forth in the claims. The foregoing description is therefore considered in all respects to be illustrative and not restrictive. The scope of the invention is indicated by the appended claims, and all changes that come within the meaning and range of equivalents thereof are intended to be embraced therein.

What is claimed is:

1. A computer system comprising a programmed computer, said programmed computer comprising computer-readable instructions and data stored on a computer-readable medium accessible by said programmed computer, said computer-readable instructions implementing a process for a source-independent server interface accepting origin-specific commands, said computer system comprising:
a computer;
a computer-readable medium coupled to said computer, said computer-readable medium comprising computer-readable instructions and data, said computer-readable instructions and data configured to perform an automated process to be executed by said computer, said automated process comprising the steps of:
accepting a request to execute a command from a command origin of a plurality of command origins;
constructing an origin-independent command object;
submitting said origin-independent command object to an execution framework for execution; and
executing a command of said origin-independent command object by forwarding to an origin proxy of said execution framework said origin-independent command object with a result-reporting object.

2. The computer system of claim 1 wherein said plurality of command origins further comprises at least an internal origin and a network origin.

3. The computer system of claim 1 further comprising preliminary steps of:
constructing said command in a client application;
serializing said command in preparation for transmission of said command to said automated process; and
deserializing said command in preparation for constructing said origin-independent command object.

4. The computer system of claim 3 further comprising:
retrieving a result of executing said command and serializing said result for return transmission to said client application.

5. The computer system of claim 3 wherein said serialized command is transmitted to said execution framework over TCP/IP.

6. The computer system of claim 1 wherein said executing further comprises performing an ancillary function selected from the group consisting of:
logging operations during said execution;
monitoring operations during said execution;
recording timing of said execution;
locking a resource;
journaling transactions during said execution; and
handling errors during said execution of said command;
whereby said ancillary function is performed in same manner for each of said plurality of command origins.

7. The computer system of claim 1 wherein said command origin is selected from the group consisting of: an internal origin, a legacy application program interface, a replication origin, and a remote function call interface.

8. A tangible computer-readable storage medium encoded with computer program instructions that when accessed by a computer cause said computer to load said computer program instructions into a computer-readable memory medium therein creating a data structure causing said computer to operate as a programmed computer programmed to execute a method providing source-independent server interface accepting origin-specific commands, said computer program instructions performing said method, said method comprising the steps of:
accepting a request to execute a command from a command origin of a plurality of command origins;
constructing an origin-independent command object;
submitting said origin-independent command object to an execution framework for execution; and
executing a command of said origin-independent command object by forwarding said origin-independent command object to an origin proxy of said execution framework.

9. The method of claim 8 wherein said plurality of command origins further comprises at least an internal origin and a network origin.

10. The method of claim 8 further comprising preliminary steps of:
constructing said command in a client application;
serializing said command in preparation for transmission of said command to said execution framework; and
deserializing said command in preparation for constructing said origin-independent command object.

11. The method of claim 10 further comprising:
retrieving a result of executing said command and serializing said result for return transmission to said client application.

12. The method of claim 10 wherein said serialized command is transmitted to said execution framework over TCP/IP.

13. The method of claim 8 wherein said executing further comprises performing an ancillary function selected from the group consisting of:
logging operations during said execution;
monitoring operations during said execution;
recording timing of said execution;
locking a resource;
journaling transactions during said execution; and
handling errors during said execution of said command;
whereby said ancillary function is performed in same manner for each of said plurality of command origins.

14. The method of claim 8 wherein said command origin is selected from the group consisting of: an internal origin, a legacy application program interface, a replication origin, and a remote function call interface.

15. A computer program product for source-independent server interface accepting origin-specific commands, said computer program product comprising computer-readable program code, said computer-readable program code executing in a tangible memory medium and configured to:
accepting a request to execute a command from a command origin of a plurality of command origins;
constructing an origin-independent command object;
submitting said origin-independent command object to an execution framework for execution; and
executing a command of said origin-independent command object by forwarding said origin-independent command object to an origin proxy of said execution framework.

16. The computer program product of claim 15 wherein said plurality of command origins further comprises at least an internal origin and a network origin.

17. The computer program product of claim 15 further comprising preliminary steps of:
constructing said command in a client application;
serializing said command in preparation for transmission of said command to said execution framework; and
deserializing said command in preparation for constructing said origin-independent command object.

18. The computer program product of claim 17 further comprising:
retrieving a result of executing said command and serializing said result for return transmission to said client application via TCP/IP.

19. The computer program product of claim 15 wherein said executing further comprises performing an ancillary function selected from the group consisting of:
logging operations during said execution;
monitoring operations during said execution;
recording timing of said execution;
locking a resource;
journaling transactions during said execution; and
handling errors during said execution of said command;
whereby said ancillary function is performed in same manner for each of said plurality of command origins.

20. The computer program product of claim 15 wherein said command origin is selected from the group consisting of: an internal origin, a legacy application program interface, a replication origin, and a remote function call interface.
